(19) United States
(12) Patent Application Publication
(10) Pub. No.: US 2026/0127604 A1
(43) Pub. Date: May 7, 2026

(54) METHODS AND SYSTEMS FOR INTERACTING WITH A DATA ANALYTICS SYSTEM VIA A MESSAGING APPLICATION

(71) Applicant: The Toronto-Dominion Bank, Toronto (CA)

(72) Inventors: Tarundeep DHOT, Toronto (CA); Katarzyna Dorota WYROSLAK, Limoges (CA); Mohsen RAZA, Toronto (CA); Bote JIANG, Toronto (CA); Abdullah Al Hamour Al Jarad, London (CA); Shan GAO, Toronto (CA); Jung Won BAEK, Toronto (CA)

(21) Appl. No.: 18/935,208

(22) Filed: Nov. 1, 2024

(51) Int. Cl. G06Q 30/02

(52) U.S. Cl. CPC G06Q 30/02

(57) ABSTRACT

Methods and system for interacting with a data analytics system using a messaging application. The system comprises a data analytics system for analyzing one or more sets of data, a context server and a chatbot. The data analytics system detects an alert condition in data, and sends an alert message to a context server. The context server obtains contextual data related to the alert message and transmit the alert message and the contextual data to the chatbot. The chatbot generates an alert chat message based on the alert message and the contextual data, and sends the generated alert chat message to a chat group in a messaging application. The chatbot may employ natural language processing (NLP) to interpret the contextual data.

### TECHNICAL FIELD

The disclosed example embodiments relate to computer-implemented methods and systems for interacting with data analytics systems, and more specifically, data analytics system dashboards, via a messaging application.

### BACKGROUND

In many computing environments, systems exist to log and monitor events. In many instances, such systems will handle a large volume of events that can total in the millions or even billions of events daily. Depending on the type of events, there may be a need to monitor the events—continuously and in real-time—at a variety of granularity levels to identify anomalous activity, which can be due to malicious actors, or could be a sign of a system that is not functioning as expected.

In some cases, data analytics software, such as, but not limited to, Tableau™ from Salesforce™, can be used to analyze the event data and visually present the results of the analysis in a dashboard. In some cases, the data analytics software can monitor the event data to identify anomalies due to, e.g., faults or malicious activity (e.g., fraud), and, in response to identifying an anomaly, present an alert or other notification in the dashboard. A user may be able to log in to the dashboard to view the results of the analysis and any alerts or notifications. The dashboard may display a large amount of information which may be difficult or infeasible to adequately present on a small screen, such as, but not limited to, a mobile device. Specifically, a small screen may make it difficult or impossible to interact with the data and the controls. Thus, it may be preferable to access the dashboard from a laptop or desktop computer.

In some cases, the data analytics software can be configured to send an email alert to one or more users when an anomaly has been detected. In response to receiving such an email alert, the user may access a laptop or desktop computer and log in to the dashboard to view the details regarding the alert and/or address the alert. However, this process can cause a delay in a user responding to such an alert, especially when an alert arises outside of the user's working hours, since the user (i) may not be actively monitoring their work email during that time; and/or (ii) may not have ready access to a laptop or desktop computer. For example, the user may only have ready access to a mobile device (e.g., mobile phone). Accordingly, it may be desirable for a user to be able to access and interact with the dashboard from a mobile device.

### SUMMARY

The following summary is intended to introduce the reader to various aspects of the detailed description, but not to define or delimit any invention.

A first aspect provides a computing system for interacting with a data analytics system, the computing system comprising: a data analytics system for analyzing one or more sets of data and generating results of the analyzing, the data analytics system configured to, in response to detecting an alert condition in the one or more sets of data, send an alert message to a context server; the context server configured to, in response to receiving the alert message, obtain contextual data related to the alert message and transmit the alert message and the contextual data to a digital communication agent; and the digital communication agent configured to, in response to receiving the alert message and the contextual data, generate an alert chat message based on the alert message and the contextual data, and send the generated alert chat message to a chat group in a messaging application, wherein the chat group comprises the digital communication agent and one or more other members.

The data analytics system may be further configured to visually present the results of the analyzing in a dashboard.

The digital communication agent may be further configured to: receive, in response to the alert chat message, an update chat message in the chat group, the update chat message requesting an update to the data analytics system; and in response to receiving the update chat message, cause the requested update to be made to the data analytics system.

The digital communication agent may be configured to cause the requested update to be made to the data analytics system by causing a command to effect the requested update on the data analytics system to be generated and sent to the context server; and the context server may be configured to save the received command and the data analytics system may be configured to obtain and execute the saved command so as to effect the requested update to the data analytics system.

The data analytics system may be further configured to visually present the results of the analyzing in a dashboard and the requested update may comprise a request to display a message in the dashboard.

The data analytics system may be further configured to, when the alert condition is detected, raise an alert in the data analytics system; and the requested update may comprise a request to clear the alert in the data analytics system.

The data analytics system may be further configured to visually present the results of the analyzing in a dashboard, and, when the alert condition is detected, update the dashboard to indicate that the alert condition has been detected, and wherein clearing the alert in the data analytics system comprises updating the dashboard to indicate that the alert has been cleared.

The digital communication agent may be further configured to: receive a data request chat message in the chat group, the data request chat message requesting data from the data analytics system; and in response to receiving the data request chat message, cause the requested data from the data analytics system to be obtained.

The digital communication agent may be configured to cause the requested data from the data analytics system to be obtained by causing a command to obtain the requested data to be generated and sent to the context server; the context server may be configured to save the received command; and the context server or the data analytics system may be configured to execute the command to obtain the requested data.

The context server may be configured to send the obtained requested data to the digital communication agent; and the digital communication agent may be configured to, in response to receiving the obtained requested data, generate a chat message based on the obtained requested data, and send the chat message to the chat group.

The digital communication agent may comprise a list of commands that each cause specific data of the data analytics system to be obtained, and each command in the list is associated with a keyword; and the digital communication agent may be configured to, when the data request message comprises a keyword associated with one of the commands in the list, use the command associated with the keyword as the command to obtain the requested data.

The data request chat message may be in a first format and the command to obtain the requested data may be a second, different, format understandable by the context server.

The alert chat message may comprise preliminary information and a link to detailed information.

The data analytics system may be configured to send an alert email that comprises the alert message, and the context server may be configured to extract the alert message from the alert email.

The context server may be configured to extract data from the data analytics system and store the extracted data on the context server, and the contextual data may be obtained from the extracted data stored on the context server.

The computing system may further comprise a cloud-based server, and the digital communication agent may reside on the cloud-based server.

A second aspect provides a method for interacting with a data analytics system, the method executed in a computing environment comprising a data analytics system for analyzing one or more sets of data and generating results of the analyzing, a context server and a digital communication agent, and the method comprising: detecting, at the data analytics system an alert condition in the one or more sets of data; sending, from the data analytics system, an alert message identifying the alert condition to the context server; obtaining, at the context server, contextual data related to the alert message; transmitting, from the context server, the alert message and the contextual data to the digital communication agent; generating, at the digital communication agent, an alert chat message based on the alert message and the contextual data; and sending, from the digital communication agent, the generated alert chat message to a chat group in a messaging application, wherein the chat group comprises the digital communication agent and one or more other members.

The method may further comprise presenting, using the data analytics system, the results of the analyzing in a dashboard.

The method may further comprise receiving, in response to the alert chat message, an update chat message at the digital communication agent via the chat group, the update chat message requesting an update to the data analytics system; and causing, at the digital communication agent, the requested update to be made to the data analytics system.

According to some aspects, the present disclosure provides a non-transitory computer-readable medium storing computer-executable instructions. The computer-executable instructions, when executed, configure one or more processors to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a block diagram of an example system for interacting with a data analytics system using a messaging application;

FIG. 2 is a schematic diagram of an example dashboard which may be generated by a data analytics system;

FIG. 3 is a schematic diagram of an example alert chat message displayed in an example messaging application;

FIG. 4 is a schematic diagram illustrating the flow of data/communications through the system of FIG. 1 to cause an alert to be presented in a chat group of the messaging application after an alert condition has been detected by the data analytics system;

FIG. 5 is a schematic diagram of an example command chat message displayed in an example messaging application;

FIG. 6 is a schematic diagram illustrating the flow of data/communications through the system of FIG. 1 to cause an alert in the data analytics system to be suppressed via a chat message in a chat group of the messaging application;

FIG. 7 is a flow diagram of an example method of using a messaging application to alert users of an alert condition detected by a data analytics system;

FIG. 8 is a flow diagram of an example method of using a messaging application to obtain information from or invoke a change in a data analytics system; and

FIG. 9 is a block diagram of an example computer which may be used to implement all or a portion of the system of FIG. 1 and/or execute all or a portion of the method of FIG. 7 and/or the method of FIG. 8.

### DETAILED DESCRIPTION

As described above, there are times where it may be desirable for a user to be able access and interact with data analytics software, and specifically the dashboard presented thereby, using a mobile device (e.g., mobile phone). In some cases, data analytics software providers may provide a mobile device application which, when installed on a mobile device, can be used to access the data analytics software, and specifically the dashboard presented thereby, from a mobile device. However, in some cases, using such a mobile device application to directly access the data analytics software from an enterprise computing environment may pose a security risk to the enterprise.

Accordingly, described herein are methods and systems for interacting with data analytics system, and specifically the dashboard provided thereby, from a mobile device in a secure manner. Specifically, in the methods and systems described herein a user may interact with data analytics software, and specifically a dashboard provided thereby, via a messaging application (e.g., Microsoft Teams™).

The systems described herein comprise a digital communication agent (e.g., a chatbot) that is a member of a chat group of a messaging application. The chat group also comprises one or more other members. The digital communication agent is configured to receive information from the data analytics system (e.g., dashboard) and present the received information as a chat message in the chat group. For example, the data analytics system may be configured to, in response to identifying an alert condition (e.g., an anomaly) in the one or more sets of data that it is monitoring, send (e.g., via email) an alert message to a context server. The context server may, in response to receiving the alert message, obtain contextual data related to the alert message and send the alert message along with the contextual data to the digital communication agent. The digital communication agent may then generate an alert chat message based on the alert message and the contextual data and send the generate alert chat message to the chat group to notify the other members of the chat group of the alert. This allows the other members of the chat group to be quickly and efficiently notified of an alert event in a secure manner, even when the other members of the chat group only have access to a mobile device (e.g., a mobile phone). Furthermore, by providing contextual data along with a notification alert may allow a member of the chat group to be able to decide how to handle the alert without having to log in to the data analytics system. Where the chat group comprises multiple other members, this also allows the members to communicate with each other regarding the alert.

In some cases, the digital communication agent may also be configured to receive commands for controlling the data analytics system via the chat group (e.g., from other members of the chat group) and cause the data analytics system to execute the commands. This allows the other members of the chat group to interact with the data analytics system from a mobile device (e.g., a mobile phone) in a secure manner. Specifically, in some cases, the digital communication agent may be configured to monitor the chat group for chat messages that comprise a command for the data analytics system. In response to identifying a chat message in the chat group that comprises a command for the data analytics system the digital communication agent may be configured to send the command to the context server where it is stored for further processing. The data analytics system may then be configured to retrieve the command from the context server and execute the command. A command may, for example, cause the data analytics system to clear or suppress an alert and/or display information in the dashboard.

### Notifying Users of Data Analytics System Alert Via Messaging Application

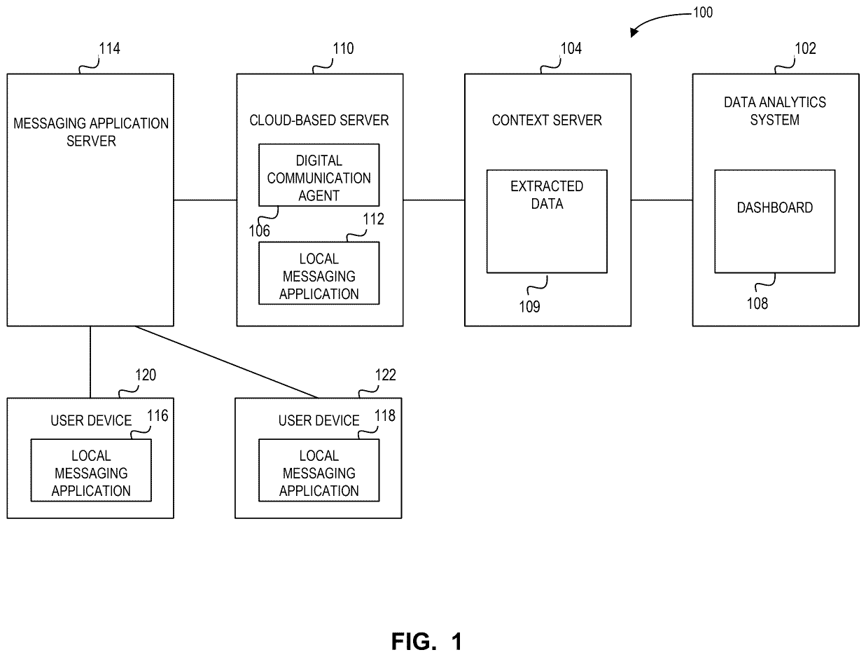

Reference is now made to FIG. 1 which illustrate a simplified block diagram of an example system 100 for interacting with a data analytics system 102. The system 100 comprises a data analytics system 102, a context server 104 communicably coupled to the data analytics system 102 and a digital communication agent 106 which is communicably coupled to the context server 104.

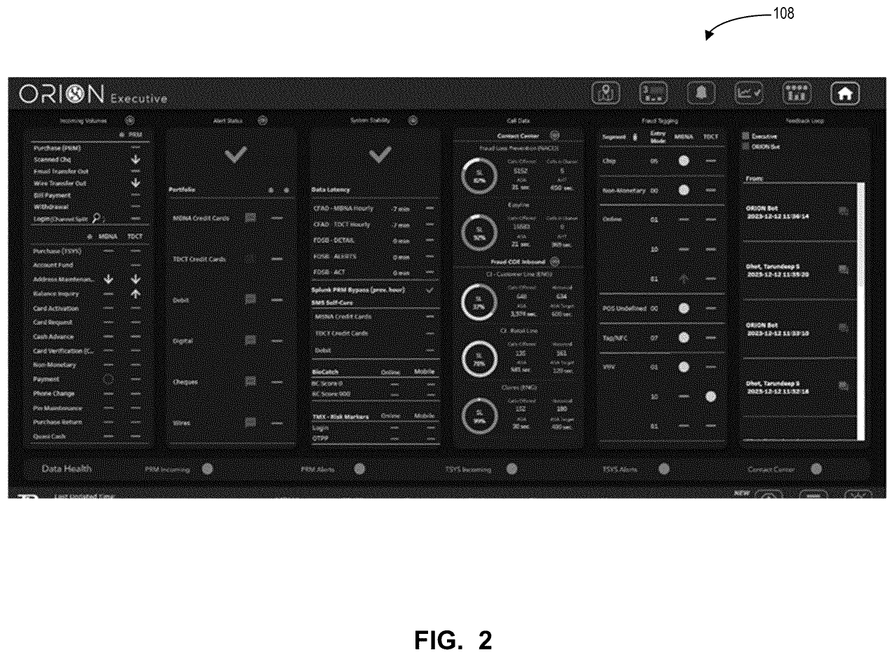

The data analytics system 102 comprises one or more computers that are configured to analyze one or more sets of data and output results of the analysis. The data analytics system 102 may be implemented by a data analytics software platform such as, but not limited to, Tableau™ from Salesforce™. In some cases, the data analytics system 102 may be configured to visually display the results of the analysis in a dashboard 108. A dashboard displays various types of visual data in one place. Dashboards often use visualizations such as, but not limited to, tables, graphs and charts. FIG. 2 illustrates an example dashboard 108. As described in more detail below, in some cases, a dashboard 108 may display alerts etc. In some cases, the dashboard 108 may be interactive. For example, the dashboard 108 may allow a user to filter data, click to dig deeper into the underlying data, and/or clear alerts etc. A user may be able to access a dashboard 108 generated by the data analytics system 102 via a web browser.

In some cases, the one or more sets of data analyzed by the data analytics system 102 may represent a set of events and the analysis performed by the data analytics system 102 may comprise real-time monitoring of the events. The set of events that are represented in the one or more sets of data can be any suitable set of events. For example, the events may relate to user account activity, such as new account openings, account changes, password resets etc. Other types of events may relate to user actions, including electronic transactions such as sent or received messages, credit card transactions, electronic fund transfers, deposit/withdrawal transactions and the like. In other contexts, the events can relate to data received from other systems including third-party systems. For example, the set of events may relate to performance data for critical systems, such as fraud activity databases, client notification systems and self-cure systems, and vendor outage data.

In some cases, one or more of the sets of data may comprise the raw data for the events. The raw data for the events may be generated by one or more sources. In other cases, the sets of data may comprise processed data that represents the events. For example, as described in U.S. patent application Ser. No. 18/466,096, which is herein incorporated by reference in its entirety, a raw source of events may be processed to produce metrics for each of a plurality of time segments. For example, raw data for each time segment may be used to update one or more staging tables with aggregate data comprised of metrics based on the raw event data over that time segment. The metric may include, for example, volumes of purchases, account deposits, address maintenances, balance inquires, card activations, card requests, cash advances, bill payments, card verification, non-monetary transactions, payments, phone number changes, PIN changes, purchase returns and electronic funds transfers. Other metrics may include connectivity levels for other systems, data latency, call centre volumes, answer speed, queue length, average handling time etc. Since only a set of one or more metrics is stored in the staging tables for each time period, the volume of data stored is significantly reduced from the raw event data. Where the data analytics system 102 is configured to display the results of the analysis in a dashboard 108, the data analytics system 102 may be configured to display one or more of the metrics for one or more time periods in the dashboard in graphical form.

The data analytics system 102 may be configured to analyze the one or more sets of data to identify alert conditions therein. What constitutes an alert condition will vary depending on what the sets of data represent and the application in which the sets of data are used. In some cases, an alert condition may be an anomaly in the one or more sets of data due to, for example, faults or malicious activity. In some cases, the data analytics system 102 may be configured to detect an anomaly in the one or more sets of data when a metric exceeds a corresponding threshold. In some cases, the threshold for a metric may be manually selected or manually configurable. In other cases, the threshold for a metric may be automatically generated by the data analytics system 102. For example, the data analytics system 102 may be configured to compute a respective threshold for each metric based on one or more past instances of the time segment. For example, the threshold may be set at 110%, 120%, 130% of historical activity. In yet other cases, thresholds may be automatically generated, but may be manually modified by a user. In some cases, each metric may have multiple thresholds. For example, a first warning threshold may be set at 130% of historical activity, and a second critical threshold may be set at 170% of historical activity.

The data analytics system 102 may be configured to, when it detects an alert condition in the one more sets of data, send an alert message to the context server 104. The alert message may comprise information identifying the detected alert condition. For example, if the alert condition was a metric exceeding a corresponding threshold, the alert message may comprise information indicating that the specific metric exceeded its threshold. For example, if an alert condition is detected when a debit alerts metric exceeds a threshold then the alert message may specify that the debit alerts metric has exceeded the threshold. In some cases, the alert message may be sent to the context server 104 via email. For example, the data analytics system 102 may be configured to send an email to the context server 104 that comprises the alert message. In such cases, the system 100 may comprise an email server (not shown) that receives the email comprising the alert message from the data analytics system 102 and sends the email to the context server 104. Where the data analytics system 102 is configured to display the results of the analysis in a dashboard 108, the data analytics system 102 may be configured to, when it detects an alert condition in the one or more sets of data, display information in the dashboard 108 that indicates that the alert condition was detected.

The context server 104 is a computer or a set of computers configured to store and retrieve data as requested by other devices or applications. In some cases, the context server may be a Microsoft™ SQL server. The context server 104 is configured to store data extracted from the data analytics system 102 and/or data input to the data analytics system 102 (e.g., the raw or processed events data).

For example, the context server 104 may be configured to periodically (e.g., hourly) extract and store data 109 from the data analytics system 102. The data from data analytics system 102 may comprise, for example, data points which the data analytics system used to generate the dashboard 108, and/or the results of the analysis performed by the data analytics system 102 (e.g., alerts or status conditions detected, summaries of data points). In some cases, the data extracted from the data analytics system is in the form of a set of files which are indexed by a look-up table. In other words, files relevant to a topic etc. can be identified from the look-up table. In addition to or alternatively to storing data extracted from the data analytics system, the context server 104 may store all or a portion of the data that is analyzed by the data analytics system. For example, the context server 104 may store the raw data or the processed data that is analyzed by the data analytics system 102. The data stored on the context server may be referred to as an automated unified dataset. Extracting and storing data from the data analytics system 102 and/or data used by the data analytics system 102, on the context server 104 allows the data analytics system 102 data to be easily queried and retrieved.

The context server 104 is configured to, when it receives an alert message from the data analytics system 102 (e.g., via an email message), obtain (from the data 109 stored on the context server 104) contextual data related to the alert message. In some cases, the related contextual data may comprise data points related to the alert message and more particularly data points related to the alert condition that triggered the alert message. In some cases, the contextual data may comprise a compilation or list of related trigger or alert issues. In some cases, the context server 104 may be configured to obtain the contextual data related to the alert message by: (1) applying string processing on the alert message; (2) identifying topics relevant to the alert message based on the string processing; (3) cross-referencing the topics with an index of issues to identify one or more related trigger issues, and (4) compiling and outputting a compilation of related trigger issues. For example, the alert message may comprise an alert ID (which may comprise a hexadecimal key) and the alert ID can be used to search for related text in certain text files, identified from the look-up table.

Once the context server 104 has obtained contextual data related to the alert message, the context server 104 is configured to provide the alert message and the related contextual data to the digital communication agent 106. In some cases, the context server 104 may be configured to provide the alert message and the related contextual data to the digital communication agent 106 by storing the alert message and the related contextual data on the server 110 (e.g., cloud-based server) that hosts the digital communication agent 106 where it will be retrieved by the digital communication agent 106.

The digital communication agent 106 (e.g., a chatbot) is a computer program that simulates, and processes written human conversations. In other words, the digital communication agent 106 can understand and respond to a human user's comments and questions. The digital communication agent 106 may use artificial intelligence (AI) techniques such as, but not limited to, natural language processing (NLP) to understand a user's question or comment and automatically formulate a response and/or automatically perform an action. In some cases, the digital communication agent 106 may be implemented by Microsoft™ Power Automate™. The digital communication agent 106 may be implemented on, or hosted by, one or more computers or servers 110. In some cases, the digital communication agent 106 may be implemented on, or hosted by, one or more cloud-based servers 110 (e.g., one or more Microsoft™ OneDrive™ servers).

The digital communication agent 106 is a member of a chat group of a messaging application. The term messaging application is used herein to include instant messaging applications or the like such as, but not limited to, Microsoft™ Teams™ and WhatsApp™ that allow real time communication over a computer network, such as, but not limited to an intranet and the Internet, and does not include email applications. The chat group also comprises one or more other members. In some cases, the other members of the chat group may be users that have access to the data analytics system 102 (or the dashboard 108 thereof). The digital communication agent 106 is configured to write or post chat messages to the chat group and may optionally be configured to receive, and respond to, chat messages in the chat group.

Specifically, the digital communication agent 106 (e.g., chatbot) is configured to, in response to receiving an alert message and the related contextual data from the context server 104, generate an alert chat message based on the alert message and the contextual data and send the generated alert chat message to the chat group to alert the other members of the chat group of the detected alert condition. This allows the other members of the chat group to be quickly and efficiently notified of alert conditions detected by the data analytics system 102, even when the only computing device available to them is a mobile device (e.g., mobile phone) that has access to the messaging application. Since alerts can be received on the go via a mobile device the described system 100 reduces the risk of an alert being missed out of hours or when the users responsible for responding to the alert are away from their laptop or desktop computer.

In some cases, the digital communication agent 106 is configured to send the generated alert chat message to the chat group by providing the alert chat message to the chat group in a local client messaging application 112 which causes the alert chat message to be sent to a messaging application server 114. The messaging application server 114 may then provide the alert chat message to each local client messaging application 116, 118 (running on an end user device 120, 122) associated with a member of the chat group. The end user devices 120, 122 may be any devices, such as, but not limited to mobile devices (e.g., mobile phones), desktop computers, and laptops that can run a client messaging application and are communicably coupled to (e.g., can communicate with) the messaging application server 114. Providing the contextual data along with the alert message can reduce the workload on end users to address the alert. Specifically, by providing them with information related to the alert the user may be able to decide whether the alert needs to be addressed (and, optionally how to address the alert) based on the provided information without having to login or otherwise access the data analytics system 102 via a laptop or desktop.

In some cases, the alert chat message comprises preliminary alert data and a link to more detailed data about the alert. A member of the chat group may be able to access the more detailed data by clicking on, or otherwise activating, the link. Excluding the detailed data in the alert chat message may reduce the size of the alert chat message which may reduce the latency or time for the alert chat message to be received by the other members of the chat group. In some cases, the preliminary message may be smaller (e.g., in terms of bits or bytes) than the detailed data.

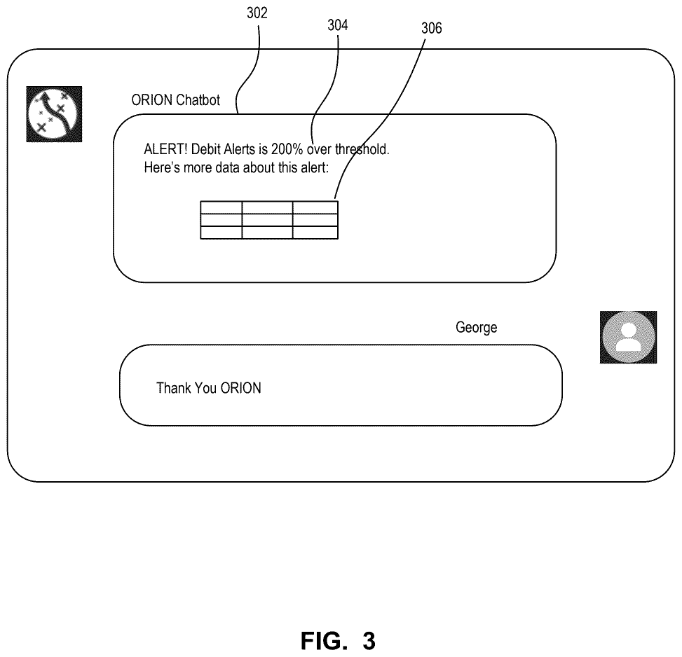

In some cases, the preliminary message may, for example, comprise information indicating that the chat message relates to an alert, a brief description of the alert condition that caused the alert (e.g., which threshold was exceeded and/or by how much), and information indicating that addition information can be obtained by clicking on the link in the alert chat message. FIG. 3 illustrates an example alert chat message 302. In this example, the preliminary message 304 specifies “ALERT! Debit Alerts is 200% over threshold. Here's more data about this alert:”. The preliminary message 304 is followed in the alert chat message by a link 306 to the detailed data. This is just an example of what the preliminary message may comprise and in other examples the preliminary message may comprise additional information, a subset of this information and/or a different set of information.

In some cases, the detailed data (accessible via the link in the alert chat message) may comprise all or a portion of the contextual data. For example, the detailed data may comprise one or more data points relevant to the alert condition that was detected. In some cases, the detailed data may be stored in memory (not shown) of the computer or server 110 which implements or hosts the digital communication agent 106, and when the user clicks on, or otherwise activates the link, the detailed data is retrieved from the memory and displayed to the user.

In some cases, clicking on the link may cause the detailed data to be displayed within a window of the messaging application (e.g., the same window in which the chat messages are displayed or another window). For example, clicking on the link may cause a sub-window to appear within the messaging application chat window in which the detailed data is displayed. In other cases, clicking on the link may cause a separate application to be launched and the detailed data may be displayed within a window of that application.

In some cases, the data received from the context server 104 (e.g., the alert message and the contextual data) may be in one format and chat messages in the messaging application may be a different format and generating the alert chat message may comprise converting the data received from the context server 104 from the first format to the second format. For example, in some cases, the context server 104 may be a SQL server and the data received from the context server 104 (e.g., the alert message and the contextual data) may be in SQL data format, and the chat messages may be in a JSON (JavaScript Object Notation) format. In these cases, the digital communication agent 106, or an application running on the server 110 that hosts the digital communication agent 106, may be configured to convert the data received from the context server 104 from SQL data format to JSON format. In some cases, the digital communication agent 106 or the context server 104 may be configured to run or execute an application (e.g., a Python™ script) to convert between the two formats.

In some cases, the digital communication agent 106 may be a member of multiple chat groups of the messaging application and the digital communication agent 106 may be configured to send the same alert chat message to each chat group. In some cases, the different chat groups that the digital communication agent 106 is a member of may have different members and may have different privileges. For example, as described in more detail below, in some cases, a member of a chat group may be able to not only receive alerts from the data analytics system 102 but may also be able to send commands to the data analytics system 102 to, for example, retrieve information and/or perform an operation (e.g., clear an alert). In such cases, different chat groups may have different privileges. For example, the members of a first chat group may only be able to receive alerts and request information but are not allowed to perform operations (e.g., clear an alert); whereas the members of a second chat group may be able to receive alerts, request information and perform operations. In such an example, the first chat group may be for junior personnel (e.g., junior analysts etc.), and the second chat group may be for senior personal (e.g., senior analysts or executives etc.). In such cases, the digital communication agent 106 may be configured to determine whether a command issued by a member can be performed based on the chat group the member is associated with.

Alternatively to having multiple chat groups, or in addition to having multiple chat groups, the members (e.g. their accounts in the messaging application) may be tied or linked to a personnel database, which stores their related role-based accessibility permissions for initiating interactions with the data analytics system 102 via the digital communication agent 106 and the digital communication agent 106 and/or the data analytics system 102 may be configured to determine whether a member can perform a desired action based on the one or more roles associated with the member.

Once the digital communication agent 106 has sent an alert chat message to the chat group, the other members of the group may use the chat group to exchange messages amongst themselves regarding the alert. This helps avoid a miscommunication amongst a team of users designated to address such alerts. Specifically, the members can quickly discuss whether the alert requires any action and if so, who is going to take the action. As discussed in more detail below, in some cases the system 100 can also be used to control the data analytics system 102 and/or retrieve information from the data analytics system 102. In these cases, the user may be able to request additional information and/or suppress or clear the alert via chat messages sent in the chat group.

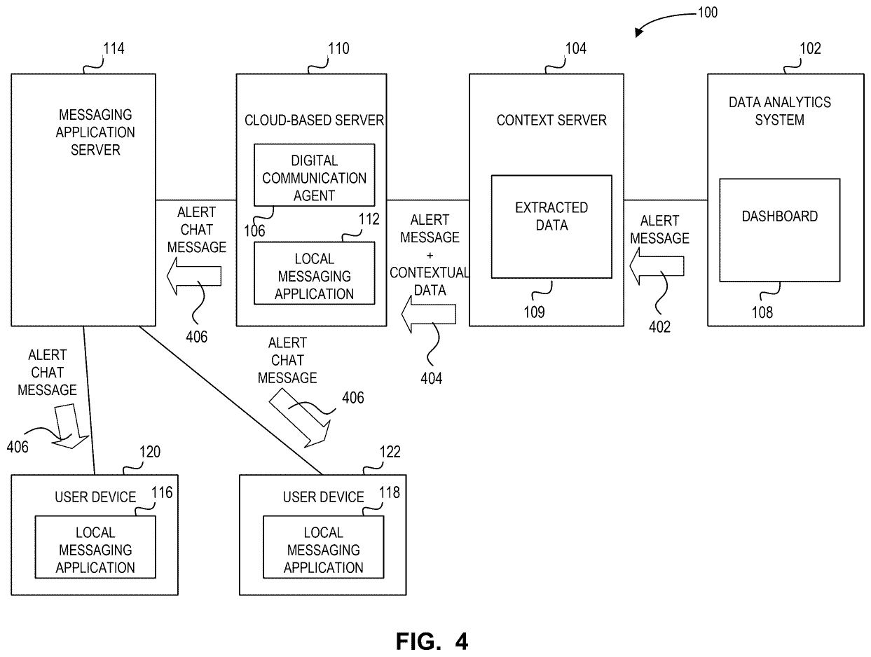

Reference is now made to FIG. 4 which illustrates an example flow of data/communications through the system 100 of FIG. 1 to enable an alert message, and related contextual data, to be automatically sent to a chat group in response to a data analytics system 102 detecting an alert condition. Specifically, when the data analytics system 102 detects an alert condition it sends an alert message 402 to the context server 104. In response to receiving the alert message 402, the context server 104 obtains contextual data related to the alert message and sends the alert message and the contextual data 404 to the digital communication agent 106. The digital communication agent 106 then generates an alert chat message 406 based on the alert message and the contextual data 404 and sends the alert chat message 406 to the chat group.

Issuing Commands to the Data Analytics System from the Messaging Application

Returning back to FIG. 1, in some cases, in addition to, or alternatively to, the system 100 of FIG. 1 being configured to allow users to be notified of an alert detected by the data analytics system 102 via a messaging application, the system 100 of FIG. 1 may be configured to allow a user to interact with the data analytics system 102 via the messaging application. Specifically, the system 100 of FIG. 1 may allow a user to issue commands in the chat group to obtain data from/used by the data analytics system 102 and/or cause a change to the data analytics system 102 which are then be executed by the context server 104 and/or the data the data analytics system 102. These commands may be referred to herein as data analytics system commands.

The data analytics system commands that a member or user may be able to issue include but are not limited to read commands and write commands. Read commands cause data from or used by the data analytics system 102 to be obtained or retrieved. In other words, a read command is a passive command in that does not result in any changes to the data analytics system 102. In contrast, write commands cause a change to be made to the data analytics system 102 (e.g., to the dashboard 108 generated thereby). For example, a write command may cause the data analytics system 102 to clear or suppress an alert on the dashboard 108 or display a message on the dashboard 108. In some cases, one or more commands may be restricted to users or members with particular privileges. For example, in some cases, only senior users or members may be able to issue write commands.

A user may issue data analytics system commands in a chat group in response to receiving an alert chat message to, for example, obtain more information related to the alert (e.g., to determine whether the alert can be cleared or suppressed); clear or suppress the alert; or display a message on the dashboard regarding the alert. A user may also be able to issue a data analytics system command in a chat group without first receiving an alert chat message to, for example, obtain data from or used by the data analytics system 102.

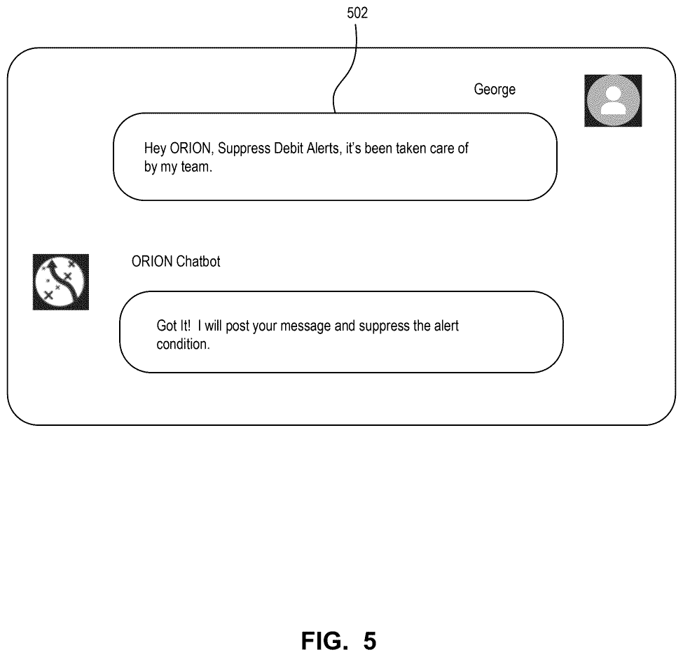

In some cases, chat messages that comprise a data analytics system command may have a predefined format (or one of a plurality of predefined formats). For example, in some cases, chat messages that comprise a data analytics system command may comprise the name of the digital communication agent, a special symbol (e.g., the pound symbol “#”) or a combination of the two. For example, if the digital communication agent's name is “ORION” then a chat message that comprises text such as “Hey ORION” may be interpreted by the digital communication agent 106 as a chat message that comprises a data analytics system command. FIG. 5 is an example command chat message 502 which may be issued by a member to cause an alert to be suppressed. The example chat message comprises the text “Hey ORION, Suppress Debit Alerts, it's been taken care of by my team.”

In some cases, the digital communication agent 106 may be configured to monitor the chat messages in each chat group it is a member of for chat messages that comprise data analytics system commands (e.g., for chat messages that comprise the predetermined pattern(s)). A chat message that comprises a data analytics system command may be referred to herein as a command chat message. A chat message that comprises a read data analytics system command may be referred to herein as a data request chat message, and a chat message that comprises a write data analytics system command may be referred to herein as an update chat message. In some cases, once the digital communication agent 106 has identified a command chat message, the digital communication agent 106 may be configured to extract or identify the command from the command chat message and send a corresponding command to the context server 104 for storage and further processing. In some cases, the command may be identified from the command chat processing using NLP and/or string processing. In some cases, the digital communication agent 106 may be configured to send additional information to the context server 104 along with the corresponding command such as the date and/or time the command chat message was sent or received and/or the member or user who sent the command chat message.

In other cases, once the digital communication agent 106 has identified a command chat message in a chat group, the digital communication agent 106 may be configured to store the command chat message (optionally along with other information such as, but not limited to, the date and/or time the message was received or sent and/or the member or user who sent the message) on the server 110 that hosts the digital communication agent 106. In these cases, code (e.g., a Python script) may be run on the server 110 that periodically scans the saved messages for new command chat messages, and when a new command chat message is identified, extracts the command from the command chat message and sends the command (optionally along with other information such as, but not limited to, the data and/or time the message was received or sent and/or the member or user who sent the message) to the context server 104 for storage and further processing. In some cases, chat messages may be in a first format and the data analytics system 102 and/or the context server 104 may be configured to understand and execute commands in a second, different, format, and the code (e.g., Python™ script) may be configured to convert command chat messages in the first format to commands in the second format. For example, the first format may be the JSON format and the second format may by the SQL format and the code may be configured to convert from JSON to SQL.

In some cases, the digital communication agent 106 or the code may be configured to only send the corresponding command to the context server 104 if the member that sent or issued the command chat message has appropriate permissions to issue the command. The digital communication agent 106 or the code may be configured to determine that the member has the appropriate permissions if one or more roles (as set out in the personnel database) associated with the member has permission to perform the command.

The data analytics system 102 is configured to obtain commands from the context server 104 and execute the commands. For example, in some cases, the data analytics system 102 may be configured to periodically scan the context server 104 for new commands. When the data analytics system 102 identifies a new command on the context server 104, the data analytics system 102 may obtain (e.g., download) the command and then execute the command.

The data analytics system 102 may be configured to execute a read command by obtaining or compiling the requested data and saving the requested data on the context server 104. The context server 104 may then be configured to send the requested data to the digital communication agent 106 (e.g., by storing the requested data on the server 110 that hosts the digital communication agent 106). The digital communication agent 106 may then be configured to generate a chat message based on the requested data and send the chat message to the chat group(s). In some cases, the chat message may comprise the entirety of the requested data. In other cases, the chat message may comprise a link to the requested data which, when clicked on (or otherwise activated) by a member of the chat group, displays the requested data to the member. In some cases, read commands can be used to obtain data that is available via the dashboard 108. This allows members or users to effectively view aspects of the dashboard 108 without having to login to the dashboard via a laptop or desktop computer.

The data analytics system 102 may be configured to execute a write command by updating the data analytics system 102 in accordance with the command. For example, if a write command indicates that an alert is to be cleared or suppressed then the data analytics system 102 may update the dashboard 108 to indicate that the alert has been cleared; or if a write command indicates that a message is to be displayed in the dashboard 108 then the data analytics system 102 may be configured to display the message in the dashboard. In the latter example, the data analytics system 102 may also be configured to display the name of the member or user who generated the message and the date and/or time they generated the message.

In some cases, the data analytics system 102 may be configured to, before executing a read or write command, first determine whether the member or user that issued the command has the required permissions to issue the command. In some cases, the data analytics system 102 may be configured to determine (from the personnel database) that a member or user has the required permission to issue the command if the user is associated with at least one role that has permission to issue the command.

In some cases, instead of the data analytics server 102 executing all of the data analytics commands received from the digital communication agent 106, the data analytics system 102 may only execute a subset of the commands received from the digital communication agent and the context server 104 may be configured to execute a subset of the commands. For example, since the context server 104 extracts and stores data 109 from, and/or used by, the data analytics system 102, the context server 104 may be configured to execute read commands by retrieving the requested information from the data 109 stored on the context server 104.

In some cases, there may be a predefined set of data analytics system commands which are each associated with a unique set of characters (e.g., letters and/or symbols), which may be referred to herein as the command keyword, and a user may trigger the issuance of the command by entering the keyword for that command in the chat group. In these cases, the digital communication agent 106 may be configured to, when it detects one of the command keywords in a chat message, automatically generate a corresponding command that is understandable by the context server 104 and/or the data analytics system 102 and send the generated command to the context server 104 for processing. Using a predefined keyword instead of writing out a command in a chat message using a natural language such as English may save the member or user time and may reduce the number of erroneous commands issued. The predefined set of commands may not be a complete list of supported data analytics system commands but may comprise a set of commonly used data analytics system commands.

In some cases, one or more of the commands may have one or more parameters which may be specified after the keyword. For example, the keyword “Suppress” may be used to trigger suppression of an alert, and the user may be able to specify which alert is to be suppressed by listing a Portfolio name after the word “Suppress”.

Table 1 comprises a list of example commands and the associated keywords which may be used to trigger issuance of the commands for an example data analytics system. Table 1 is just an example set of command-keyword pairs for an example data analytics system and other commands and keywords may be used in other data analytics systems. In some cases, a member of a chat group may be able to obtain a list of supported commands (such as those shown in Table 1) by sending a chat message in the chat group that comprises a special keyword (e.g., “#HowTo”). It is noted that Table 1 comprises acronyms such as CPM, TDCT, CFAD, TMX, FRC etc. which are specific to this example and their specific meaning is not relevant to the described embodiments.

TABLE 1

| Command Keyword | Description of Command |
|---|---|
| #acesss [email] | To request access to the data analytics system (which |
| | may be referred to herein as ORION), type #access |
| | followed by a list of emails. |
| | ex. #access ted.smith@abc.com |
| Suppress [Portfolio] | To suppress an alerted fired by an alert condition in the |
| [Alerts/SMS] | data analytics system. |
| | Ex. Suppress Debit Alerts |
| #CPMTeams | To view the email distribution per team in CPM. |
| #OrionSnapshot | To receive a screenshot of a real-time data analytics |
| | system dashboard 1 via email |
| #TDCTSnapshot | To receive a screenshot of a real-time data analytics |
| | system dashboard 2 via email |
| #BioCatch | To view BioCatch health indicator |
| #CFADLag | To view latency of CFAD tables |
| #CallData | To view Contact Center data and Fraud COE Inbound |
| | Call Health |
| #FraudTagging | To view fraud tagging details |
| #HealthCheck | To view health status on incoming volumes for |
| | TSYS/PRM, alerts, latency, SMS, fraud tagging, |
| | BioCatch and TMX |
| #ORIONHealth | To view data health of the data analytics system |
| #ORIONLag | To view latency of CFAD and FDS tables used in the data |
| | analytics system |
| #SelfCure | To view current SMS self-cure status for MBNA, TDCT |
| | and Debit |
| #TMX | To view TMX health indicators |
| #CFOAlerts | To view 7-days alerts forecast by queue name for the |
| | current week |
| #CFOClaims | To view 7-day claims forecast by the current week |
| #ChequesHealth | To view alert status, the top five alerting rules, top |
| | channels and top BR CI volumes for Cheques |
| #ChequesRules | To view the top 10 alerting rules for Cheques |
| #DebitHealth | To view SMS self-cure rate, autoblocks today, top rules, |
| | and to merchants for Debit |
| #DebitRules | To view over-firing and under-firing rules for Debit |
| #DigitalFRC | To view the top 5 fraud recipient country for Digital |
| #DigitalHealth | To view the top 10 alerting rules, the top 5 login IP, alert |
| | volume, and queue penetration rate for Digital |
| #DigitalRules | To view the top 10 alerting rules for Digital |
| #IDTClaims | To view the IDT pending claims from the past 3 days |
| #QPen | To view the queue penetration information |
| #RulesDeployed | To view information about recently deployed rules |
| #SearchMerchant | To view Fraud KPIs, associated with specific TDCT |
| | Merchant by searching up its name after the command |
| #TDCTHealth | To view rolling 5 days alert volume comparison, rolling 5 |
| | days SMS breakdown by hour and merchant for TDCT |
| #TDCTMerchants | To view the top 10 alerting TDCT credit card merchants - |
| | SMS Details and Fraud KPIs |

For example, if a member of a chat group (e.g., George) sends a chat message to the chat group that comprises the text “#FraudTagging” the digital communication agent 106 may be configured to automatically generate a corresponding command, understandable by the data analytics system, to retrieve fraud tagging details and send the generated command to the context server 104 for processing. The data analytics system 102 or the context server 104 may then retrieve the fraud tagging details and send them to the digital communication agent 106 as described above. The digital communication agent 106 may then generate a chat message that comprises the retrieved fraud tagging details and sends the generated chat message to the chat group. An example of the chat message that may be generated and sent by the digital communication agent 106 is shown below.
Hi George, here are the Fraud Tagging Details
Fraud Tagging Details Today
Business A Fraud Tagging
Spikes:
Fraud Check is Healthy (No Spikes above 130% today)
Business A Merchants

| | | Fraud | | |
|---|---|---|---|---|
| Merchant | Segment | Attempts | EntryMode | Transactions |
| Merchant 1 | ONL | 17 | 81 | $12912.00 |
| Merchant 2 | ONL | 16 | 81 | $4382.00 |
| Merchant 3 | ONL | 13 | 81 | $6812.00 |
| Merchant 4 | NONMON | 7 | 0 | $0.00 |
| Merchant 5 | ONL | 7 | 10 | $7603.00 |

Business B Fraud Tagging
Spikes:

| Portfolio | Segment | Spike | EntryMode | Hour |
|---|---|---|---|---|
| Portfolio 1 | ONL | 17 | 81 | 6:00 AM |

Business B Merchants

| | | Fraud | | |
|---|---|---|---|---|
| Merchant | Segment | Attempts | EntryMode | Transactions |
| Merchant A | ONL | 6 | 81 | $1453.00 |
| Merchant B | VBV | 4 | 81 | $0.00 |
| Merchant C | ONL | 2 | 81 | $11564.00 |
| Merchant D | ONL | 2 | 0 | $1967.00 |

In another example if a member of a chat group (e.g., Melanie) sends a chat message to the chat group that comprises the text “#SearchMerchant abs” the digital communication agent 106 may be configured to automatically generate a command, understandable by the context server 104 and/or the data analytics system 102, to retrieve statistics for any merchant that has “abc” in their name, and send the command to the context server 104 for processing as described above. The data analytics system 102 or the context server 104 may then retrieve the requested merchant statistics. The retrieved merchant statistics are then sent to the digital communication agent 106 as described above. The digital communication agent 106 may then generate a chat message that comprises the retrieved merchant statistics and send the generated chat message to the chat group. An example of the chat message that may be generated and sent by the digital communication agent 106 is shown below.

Melanie, here is what I found for “abc”

| | | | | | | Frau | Fraud | Legit |
|---|---|---|---|---|---|---|---|---|
| | | | | Fraud | Legit | Auth | Appr | Auth |
| Merchant | Trans. | Fraud | Legit | Card | Card | Sum | Sum | Sum |
| ABC CO. | 2366 | 1 | 2365 | 1 | 2213 | $22.42 | $22.42 | $40500.87 |
| Sing ABC | 2317 | | 2317 | | 1734 | | | $83621.82 |
| LTD. | | | | | | | | |
| The ABC | 2226 | | 2276 | | 1214 | | | $57223.57 |
| People | | | | | | | | |
| I LOVE | 2181 | 3 | 2178 | 1 | 1622 | $0.00 | $0.00 | $16123.65 |
| MY ABCS | | | | | | | | |

In some cases, in addition to being able to receive commands for the data analytics system via chat messages, the digital communication agent 106 may also be receive commands or questions that the digital communication agent 106 can itself execute or answer. One or more of these commands or questions may also be associated with a special keyword which can trigger the command or question. For example, when a user enters the keyword “#Links” in a chat message in the chat group, the digital communication agent 106 may be configured provide, in the chat group, a list of resources such as Helpdesk, Links and Access Information; and when the user enters the keyword “#UserStats” in a chat message in the chat group, the digital communication agent 106 may be configured to provide the top users of the digital communication agent 106 and the most frequently used commands.

In some cases, the digital communication agent 106 may be configured to use natural language processing (NLP) to analyze the text of chat messages and to automatically determine the related problem/request/command described by the user. The digital communication agent 106 may then execute machine learning to analyze the problem or answer the request or execute the command.

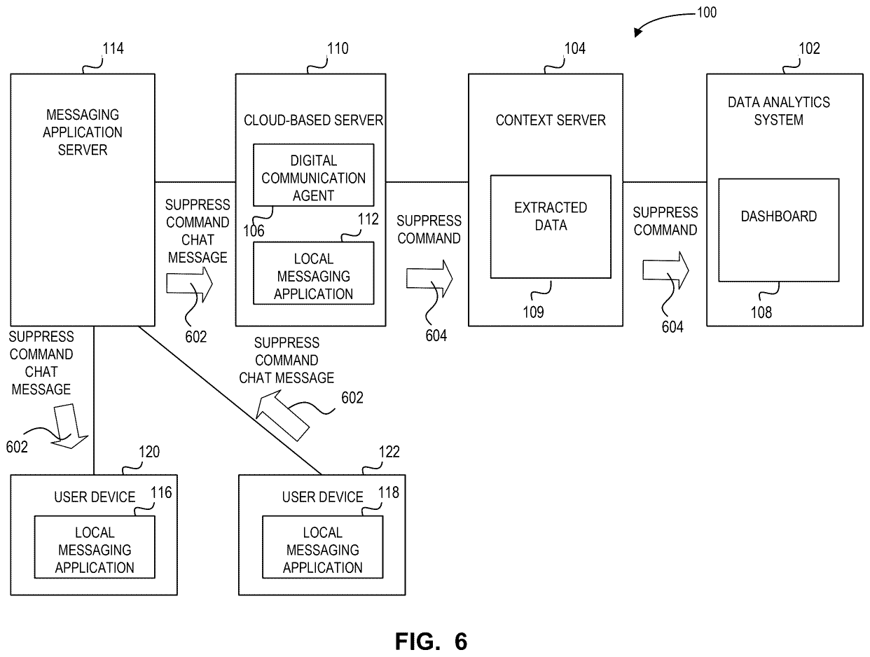

Reference is now made to FIG. 6 which illustrates an example flow of data/communications through the system 100 of FIG. 1 to enable an alert message to be suppressed or cleared via a messaging application. Specifically, after a user has been notified of an alert condition via a messaging application (e.g., as shown in FIG. 4) the user may send a command chat message 602 to the chat group that indicates the user wishes to issue a command to the data analytics system 102 to clear the alert. The command chat message 602 is picked up by the digital communication agent 106 that causes a corresponding command 604 to suppress the alert to be sent to the context server 104. The command 604 is ultimately picked up the data analytics system 102. The data analytics system 102 then executes the command to clear the alert (e.g., clear the alert in the dashboard 108 of the data analytics system 102).

### Methods

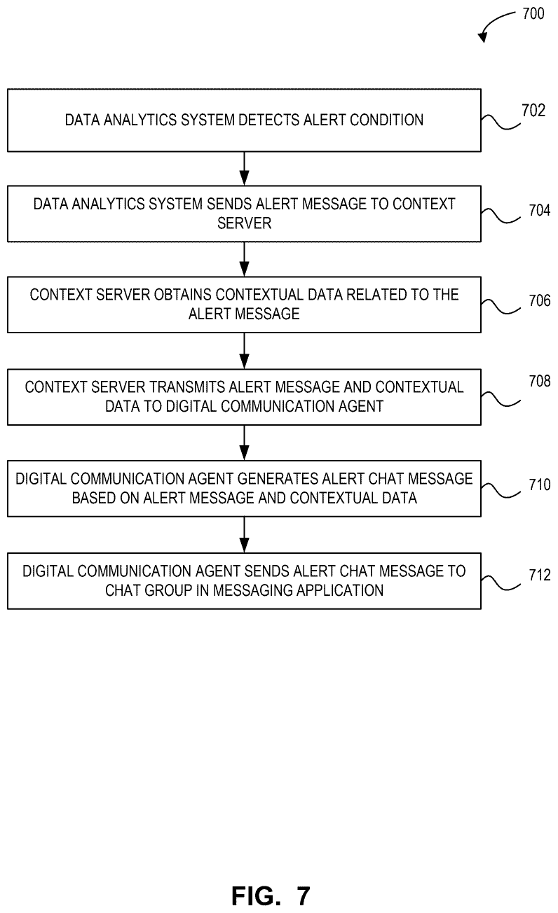

Reference is now made to FIG. 7 which illustrates an example method 700 of using a messaging application to alert users of an alert condition detected by a data analytics system, such as, but not limited to the data analytics system 102 of FIG. 1. The method 700 may be executed by the system 100 of FIG. 1. The method 700 begins at block 702 where a data analytics system (a system configured to analyze one or more sets of data and generate results of the analysis) detects an alert condition in the one or more sets of data that the data analytics system is configured to analyze. As described above, an alert condition may be detected using any suitable means. In some cases, an alert condition may be detected when a metric exceeds a threshold. Once an alert condition has been detected the method 700 proceeds to block 704.

At block 704, the data analytics system sends an alert message to a context server (a server configured to store and retrieve data). The alert message may comprise information that identifies the alert condition that triggered the alert (e.g., the threshold that was exceeded) and/or the time and/or date of the alert condition. As described above, in some cases the data analytics system may be configured to send and generate an email with the alert message and the context server is configured to receive the email and extract the alert message from the email. Once the data analytics system has sent the alert message, the method 700 proceeds to block 706.

At block 706, the context server receives the alert message and obtains contextual data related to the alert message. As described above, the context server may comprise data extracted from, and/or used by, the data analytics system and the context server may obtain the contextual data from the data stored in the context server. As described above, the context server may be configured to analyze the alert message to identify a topic etc. and use that to identify related data points. Once the context server has obtained the related contextual data, the method 700 proceeds to block 708.

At block 708, the context server sends or transmits the alert message and the contextual data to a digital communication agent. As described above, in some cases the context server may transmit the alert message and the contextual data to the digital communication agent by saving the alert message and the contextual data to a server which hosts the digital communication agent, and the digital communication agent is configured to retrieve the alert message and the contextual data from the server. Once the alert message and the contextual data have been transmitted to the digital communication agent the method 700 proceeds to block 710.

At block 710, the digital communication agent receives the alert message and the contextual data and generates an alert chat message based therein. As described above, the alert chat message may comprise preliminary alert data and a link to additional data. Once the digital communication agent has generated the alert chat message the method 700 proceeds to block 712.

At block 712, the digital communication agent sends the generated alert chat message to a chat group in a messaging application. The chat group comprises the digital communication agent and one or more other members. The alert chat message notifies the other members of the alert and allows them to quickly and easily obtain the contextual data. The method 700 then ends.

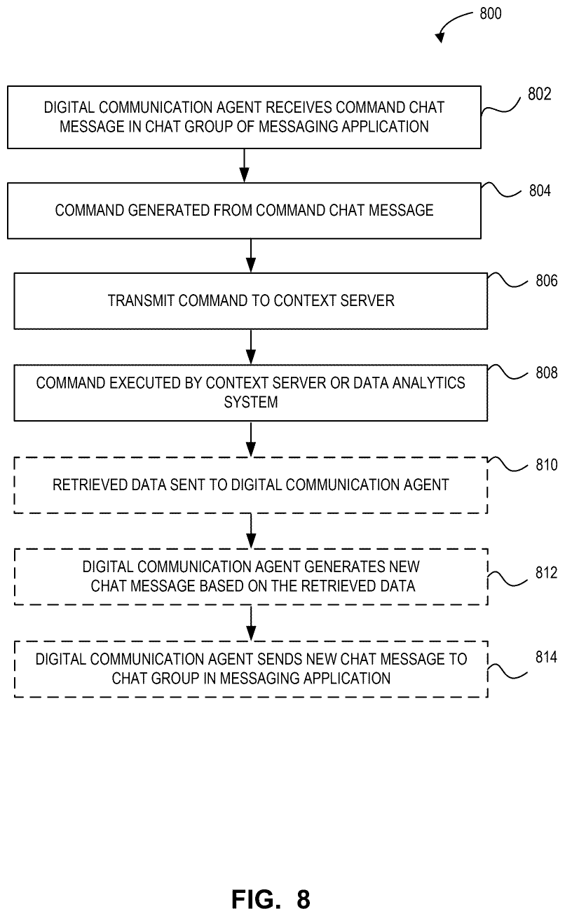

Reference is now made to FIG. 8 which illustrates an example method 800 of using a messaging application to obtain data from or about, or invoke a change in, a data analytics system, such as, but not limited to the data analytics system 102 of FIG. 1. The method 800 may be executed by the system 100 of FIG. 1.

The method begins at block 802 where a digital communication agent (e.g., digital communication agent 106 of FIG. 1) receives a chat message, via a chat group of a messaging application, that comprises a data analytics system command, which is referred to herein as a command chat message. As described above, a data analytics system command is a command to obtain data analytics system data (a read command) or to cause a change in the data analytics system (a write command). Accordingly, a command chat message may comprise a request for data analytics system data or may comprise a request to make a change to or update the data analytics system. The command chat message may be received in response to an alert chat message generated in accordance with the method 700 of FIG. 7 or the chat message may not be in response to an alert chat message generated in accordance with the method 700 of FIG. 7. In some cases, command chat messages may have one of one or more predetermined formats and the digital communication agent may be able to identify a chat message as a command chat message when it has one of the one or more predetermined formats. Once the digital communication agent has received a command chat message, the method 800 proceeds to block 804.

At block 804, the digital communication agent causes a command to be generated that causes the requested data to be obtained or causes the requested change or update to be made in the data analytics system. In some cases, the digital communication agent may automatically generate the command from the command chat message. In other cases, the digital communication agent may simply store the command chat message on the server which hosts the digital communication agent, and another application may automatically generate the command from the stored command chat message. Once the command has been generated the method 800 proceeds to block 806.

At block 806, the generated command is transmitted to the context server. In some cases, transmitting the command to the context server may comprise storing the command on the context server. Once the command has been transmitted to the context server the method 800 proceeds to block 808.

At block 808, the command is executed by either the context server or the data analytics system. Where the command is a read command, it may be executed by the data analytics system to obtain the requested data or the context server since the context server has data extracted from and/or related to the data analytics system. Where the command is a write command it may be executed by the data analytics system to effect the requested change or update to the data analytics system.

Where the command is a write command the method 800 may end after the command has been executed and the change or update has been made to the data analytics system. Where the command is a read command the method 800 may continue to block 810 where the retrieved data is sent from the context server to the digital communication agent. At block 812 the digital communication agent generates a new chat message based on the retrieved data and at block 814 the digital communication agent sends the new chat message to the chat group in the messaging application. The new message may comprise the retrieved data or a link to the retrieved data.

### Example Computer

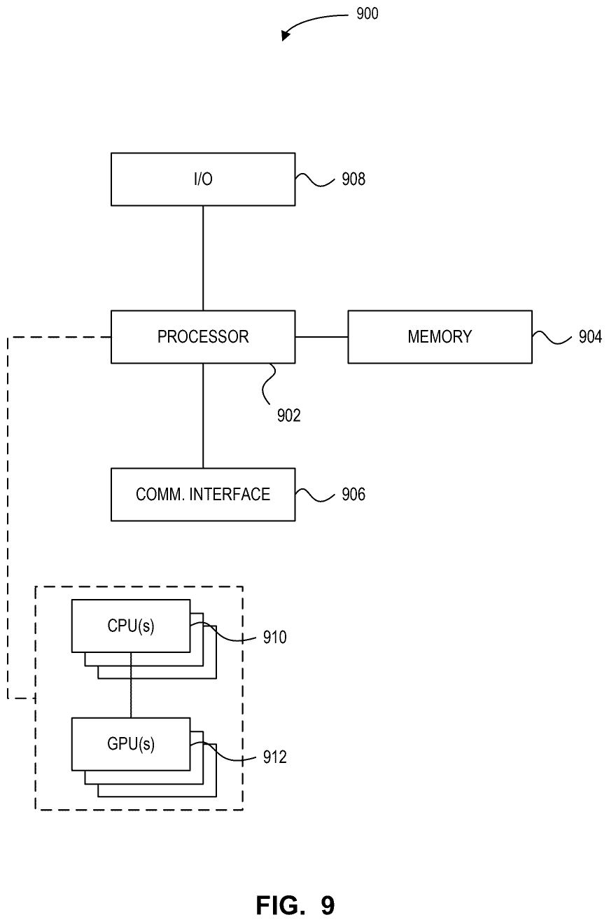

Reference is now made to FIG. 9 which illustrates a simplified block diagram of an example computer 900. Computer 900 is an example implementation of a computer which may implement all or a part of the system 100 of FIG. 1. Computer 900 has at least one processor 902 operatively coupled to at least one memory 904, at least one communications interface 906 (also referred to herein as a network interface), and at least one input/output (I/O) device 908.

The at least one memory 904 includes a volatile memory that stores instructions executed or executable by the processor 902, and input and output data used or generated during execution of the instructions. The memory 904 may also include non-volatile memory used to store input and/or output data—e.g., within a database—along with program code containing executable instructions.

The processor 902 may transmit or receive data via the communications interface 906 and may also transmit or receive data via any additional input/output device 908 as appropriate.

In some cases, the processor 902 may include a system of central processing units (CPUs) 910. In other cases, the processor 902 includes a system of one or more CPUs 910 and one or more Graphical Processing Units (GPUs) 912 that are coupled together.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A computing system for interacting with a data analytics system, the computing system comprising:
a data analytics system for analyzing one or more sets of data and generating results of the analyzing, the data analytics system configured to, in response to detecting an alert condition in the one or more sets of data, send an alert message to a context server;
the context server configured to, in response to receiving the alert message, obtain contextual data related to the alert message and transmit the alert message and the contextual data to a digital communication agent; and
the digital communication agent configured to, in response to receiving the alert message and the contextual data, generate an alert chat message based on the alert message and the contextual data, and send the generated alert chat message to a chat group in a messaging application, wherein the chat group comprises the digital communication agent and one or more other members.

2. The computing system of claim 1, wherein the data analytics system is further configured to visually present the results of the analyzing in a dashboard.

3. The computing system of claim 1, wherein the digital communication agent is further configured to:
receive, in response to the alert chat message, an update chat message in the chat group, the update chat message requesting an update to the data analytics system; and
in response to receiving the update chat message, cause the requested update to be made to the data analytics system.

4. The computing system of claim 3, wherein the digital communication agent is configured to cause the requested update to be made to the data analytics system by causing a command to effect the requested update on the data analytics system to be generated and sent to the context server; and wherein the context server is configured to save the received command and the data analytics system is configured to obtain and execute the saved command so as to effect the requested update to the data analytics system.

5. The computing system of claim 3, wherein the data analytics system is further configured to visually present the results of the analyzing in a dashboard and the requested update comprises a request to display a message in the dashboard.

6. The computing system of claim 3, wherein the data analytics system is further configured to, when the alert condition is detected, raise an alert in the data analytics system; and the requested update comprises a request to clear the alert in the data analytics system.

7. The computing system of claim 6, wherein the data analytics system is further configured to visually present the results of the analyzing in a dashboard, and, when the alert condition is detected, update the dashboard to indicate that the alert condition has been detected, and wherein clearing the alert in the data analytics system comprises updating the dashboard to indicate that the alert has been cleared.

8. The computing system of claim 1, wherein the digital communication agent is further configured to:
receive a data request chat message in the chat group, the data request chat message requesting data from the data analytics system; and
in response to receiving the data request chat message, cause the requested data from the data analytics system to be obtained.

9. The computing system of claim 8, wherein the digital communication agent is configured to cause the requested data from the data analytics system to be obtained by causing a command to obtain the requested data to be generated and sent to the context server; and wherein the context server is configured to save the received command and the context server or the data analytics system is configured to execute the command to obtain the requested data.

10. The computing system of claim 9, wherein:
the context server is configured to send the obtained requested data to the digital communication agent; and
the digital communication agent is configured to, in response to receiving the obtained requested data, generate a chat message based on the obtained requested data, and send the chat message to the chat group.

11. The computing system of claim 9, wherein:
the digital communication agent comprises a list of commands that each cause specific data of the data analytics system to be obtained, and each command in the list is associated with a keyword; and
the digital communication agent is configured to, when the data request message comprises a keyword associated with one of the commands in the list, use the command associated with the keyword as the command to obtain the requested data.

12. The computing system of claim 9, wherein the data request chat message is in a first format and the command to obtain the requested data is a second, different, format understandable by the context server.

13. The computing system of claim 1, wherein the alert chat message comprises preliminary information and a link to detailed information.

14. The computing system of claim 1, wherein the data analytics system is configured to send an alert email that comprises the alert message, and the context server is configured to extract the alert message from the alert email.

15. The computing system of claim 1, wherein the context server is configured to extract data from the data analytics system and store the extracted data on the context server, and the contextual data is obtained from the extracted data stored on the context server.

16. The computing system of claim 1, wherein the digital communication agent is a chatbot, the chatbot configured to process the contextual data using natural language processing.

17. A method for interacting with a data analytics system, the method executed in a computing environment comprising a data analytics system for analyzing one or more sets of data and generating results of the analyzing, a context server and a digital communication agent, and the method comprising:
detecting, at the data analytics system, an alert condition in the one or more sets of data;
sending, from the data analytics system, an alert message identifying the alert condition to the context server;
obtaining, at the context server, contextual data related to the alert message;
transmitting, from the context server, the alert message and the contextual data to the digital communication agent;
generating, at the digital communication agent, an alert chat message based on the alert message and the contextual data; and
sending, from the digital communication agent, the generated alert chat message to a chat group in a messaging application, wherein the chat group comprises the digital communication agent and one or more other members.

18. The method of claim 17, further comprising presenting, using the data analytics system, the results of the analyzing in a dashboard.

19. The method of claim 17, further comprising:
receiving, in response to the alert chat message, an update chat message at the digital communication agent via the chat group, the update chat message requesting an update to the data analytics system; and
causing, at the digital communication agent, the requested update to be made to the data analytics system.

20. A non-transitory computer readable medium storing computer executable instructions which, when executed by at least one computer processor, cause the at least one computer processor to carry out a method for interacting with a data analytics system, the method comprising:
detecting, at a data analytics system, an alert condition in the one or more sets of data;
sending, from the data analytics system, an alert message identifying the alert condition to a context server;
obtaining, at the context server, contextual data related to the alert message;
transmitting, from the context server, the alert message and the contextual data to a digital communication agent;
generating, at the digital communication agent, an alert chat message based on the alert message and the contextual data; and
sending, from the digital communication agent, the generated alert chat message to a chat group in a messaging application, wherein the chat group comprises the digital communication agent and one or more other members.
